(19) United States
(12) Patent Application Publication
(10) Pub. No.: US 2017/0243582 A1
(43) Pub. Date: Aug. 24, 2017

(54) HEARING ASSISTANCE WITH AUTOMATED SPEECH TRANSCRIPTION

(71) Applicant: Microsoft Technology Licensing, LLC, Redmond, WA (US)

(72) Inventors: Arul Menezes, Bellevue, WA (US); William Lewis, Seattle, WA (US); Yi-min Wang, Bellevue, WA (US)

(73) Assignee: Microsoft Technology Licensing, LLC, Redmond, WA (US)

(21) Appl. No.: 15/048,908

(22) Filed: Feb. 19, 2016

(51) Int. Cl. G10L 15/26; G10L 13/033

(52) U.S. Cl. CPC G10L 15/26; G10L 13/0335

(57) ABSTRACT

The assistive hearing device implementations described herein assist hearing impaired users of the device by using automated speech transcription to generate text representing speech received in audio signals which can then be read in a synthesized voice tailored to overcome a user's hearing deficiencies. A speech recognition engine recognizes speech in received audio and converts the speech of the received audio to text. Once the speech is converted to text, a text-to-speech engine can convert the text to synthesized speech that can be enhanced and output in a voice that compensates for the hearing loss profiles of a user of the assistive hearing device. By transcribing received speech into text the assistive hearing device implementations described herein eliminate background noise from the audio signal. By converting the transcribed text into a synthesized voice that is easier to understand to hearing impaired persons, their hearing deficiencies can be remedied.

### BACKGROUND

Traditional hearing aids consist of a microphone worn discreetly on the user's body, typically at or near the ear, a processing unit and a speaker inside of or at the entrance to the user's ear channel. The principle of the hearing aid is to capture the audio signal that reaches the user and amplify it in such a way as to overcome deficiencies in the user's hearing capabilities. For instance, the signal may be amplified more in certain frequencies than others. Certain frequencies known to be important to human understanding of speech may be boosted more than others.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In general, the assistive hearing device implementations described herein assist hearing impaired users by employing automated speech transcription to generate text representing speech received in audio signals which is then displayed for the user and/or read in a synthesized voice tailored to overcome a user's hearing deficiencies.

In some implementations, the assistive hearing device implementations use a microphone or array of microphones (in some cases optimized for speech recognition) to capture audio signals containing speech. A speech recognition engine recognizes speech (e.g., words) in the received audio and converts the recognized words/linguistic components of the received audio to text. Once the speech is converted to text, the text can be displayed on an existing device, such as, for example, the user's phone, watch or computer, or can be displayed on a wearable augmented-reality display, or can be projected directly onto the user's retina. The visual display of the text is especially beneficial in very noisy situations, for people with profound or complete hearing loss, or can simply be preferable for some users. In other implementations, a text-to-speech engine (e.g., speech synthesizer) can convert the text to synthesized speech that can be enhanced and output in a voice that compensates for the hearing loss profiles of a user of the assistive hearing device. In yet other implementations, a display of the recognized text can be used in addition to the synthesized voice. The text can be displayed to the user with or without being coordinated with the synthesized speech output by the loudspeaker or other audio output device.

The assistive hearing device implementations described herein may be implemented on a standalone specialized device, or as an app or application on a user's mobile computing device (e.g., smart phone, smart watch, smart glasses and so forth).

Various assistive hearing device implementations described herein may output synthesized (text-to-speech) speech to an earpiece or loudspeaker placed in or near the user's ear, or worn by the user in some similar manner. In some implementations, signals representing the synthesized speech may be directly transmitted to a conventional hearing aid of a user or may be directly transmitted to one or more cochlear implants of a user.

### DESCRIPTION OF THE DRAWINGS

The specific features, aspects, and advantages of the disclosure will become better understood with regard to the following description, appended claims, and accompanying drawings where:

FIG. 1 is an exemplary environment in which assistive hearing device implementations described herein can be practiced.

FIG. 2 is a functional block diagram of an exemplary assistive hearing device implementation as described herein.

FIG. 3 is a functional block diagram of another exemplary assistive hearing device implementation as described herein that can provide enhanced synthesized speech that is easier to understand for the hearing impaired and display text corresponding to received speech in one or more languages.

FIG. 4 is a functional block diagram of a system for an exemplary assistive hearing device implementation as described herein in which a server or a computing cloud can be used to share processing, for example, speech recognition and text-to-speech processing.

FIG. 5 is a flow diagram of an exemplary process for practicing various exemplary assistive hearing device implementations that output synthesized speech tailored to a particular user's hearing loss profile.

FIG. 6 is a flow diagram of an exemplary process for practicing various exemplary assistive hearing device implementations that transcribe speech into text and output the transcribed text to a display.

FIG. 7 is a flow diagram of an exemplary process for practicing various exemplary assistive hearing device implementations where synthesized speech is output that is understandable to one or more users.

FIG. 8 is an exemplary computing system that can be used to practice exemplary assistive hearing device implementations described herein.

### DETAILED DESCRIPTION

In the following description of assistive hearing device implementations as described herein, reference is made to the accompanying drawings, which form a part thereof, and which show by way of illustration examples by which implementations described herein may be practiced. It is to be understood that other embodiments may be utilized and structural changes may be made without departing from the scope of the claimed subject matter.

### 1.0 Assistive Hearing Device Implementations

The following sections provide an overview of assistive hearing device implementations, an exemplary environment in which assistive hearing device implementations described herein can be implemented, exemplary devices, a system, and a process for practicing these implementations, as well as exemplary usage scenarios.

As a preliminary matter, some of the figures that follow describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

### 1.1 Overview

In general, the assistive hearing device implementations described herein assist hearing impaired users of the device by using automated speech transcription to generate text representing speech received in audio signals which is then displayed visually and/or read in a synthesized voice tailored to overcome a user's hearing deficiencies.

Assistive hearing device implementations as described herein have many advantages over conventional hearing aids and other methods of trying to remedy hearing problems. The assistive hearing device implementations cannot only distinguish between speech and non-speech sounds, but can also recognize the words being spoken, and which speaker is speaking them, and transcribe them to text. Because the assistive hearing devices can provide enhanced synthesized speech directly to the hearing impaired in real-time, a user of the device can follow a conversation easily. Additionally, text of the speech can be displayed to the user at the same time, or nearly the same time, that the enhanced synthesized speech is output, which allows the user to go back to verify they understood portions of a conversation directly. In some implementations, only text is output. This is particularly beneficial for completely deaf participants in a conversation because they can read the transcript and participate in the conversation even if they cannot hear the speech. In some implementations the enhanced synthesized speech from one assistive hearing device is sent to another assistive hearing device over a network which allows two hearing impaired individuals to understand each other's speech even when they are not in the same room. By converting the speech in a noisy room to text and then playing a transcript of the text in an enhanced manner suited to the user's hearing loss profile directly to a loudspeaker (or conventional hearing aid or cochlear implant) in a user's ear, the user is much more likely to understand the speech than conventional hearing aids which typically just amplify the volume of all sounds, or all sounds within a particular pitch range, dictated by a user's hearing profile, whether or not the sounds are linguistic. Noise in the received audio is practically entirely eliminated.

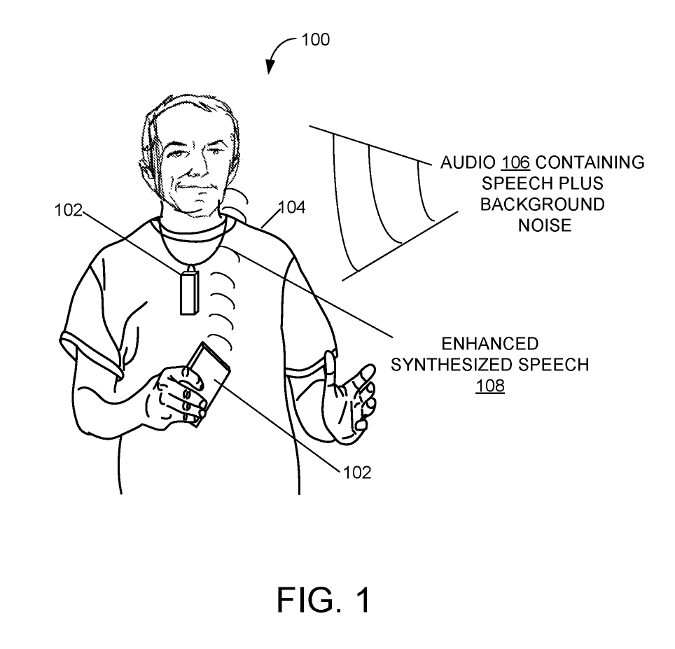

FIG. 1 depicts an exemplary environment 100 for practicing various assistive hearing device implementations as described herein. The assistive hearing device 102 can be embodied in, for example, a specialized device, a mobile phone, a tablet computer or some other mobile computing device with an assistive hearing application running on it. The assistive hearing device 102 can be worn or held by a user/wearer 104, or can be stored in the user's/wearer's pocket or can be elsewhere in proximity to the user 104. The assistive hearing device 102 includes a microphone or microphone array (not shown) that captures audio signals 106 containing speech and background noise. In some implementations the assistive hearing device 102 communicates with a loudspeaker in the user's ear, or to a traditional hearing aid or cochlear implant of the user 104 via Bluetooth or other near field communication (NFC) or other wireless communication capability.

The assistive hearing device 102 can output enhanced synthesized speech in the form of a voice based on the transcriptions of text of the speech obtained from the audio signal 106. The enhanced synthesized speech 108 can be output in a manner so that the pitch or other qualities of the voice used to output the synthesized speech are designed to overcome a hearing loss profile of the wearer/user 104 of the assistive hearing device 102. This will be discussed in greater detail later. As discussed above, in some implementations the enhanced synthesized speech is output to a loudspeaker near the user's ear, but in some assistive hearing device implementations the enhanced speech 108 is not output to a loudspeaker and is directly injected into the processor of a conventional hearing aid (e.g., via a secondary channel on the hearing aid) or directly injected into the cochlear implant(s) of a person wearing them (e.g., via a secondary channel on the cochlear implant).

The assistive hearing device implementations use a microphone or array of microphones to capture audio 106 signals containing speech. A speech recognition engine that recognizes speech in the received audio converts the speech components of the received audio to text. A text-to-speech engine can convert this text to synthesized speech. This synthesized speech can be enhanced and output in a voice that compensates for the hearing loss profiles of a user of the assistive hearing device. By transcribing received speech into text the assistive hearing device implementations described herein eliminate background noise from the audio signal. By converting the transcribed text by reading it with a synthesized voice that is easier to understand to hearing impaired persons, the hearing deficiencies of a given person or a group of people can be remedied.

The microphone or array of microphones may be worn by a user, or may be built into an existing wearable device, such as smart glasses, a smart watch, a necklace and so forth. In some assistive hearing device implementations, the microphone or array of microphones may simply be the standard microphone of a user's smart phone or other mobile computing device. The microphone or array of microphones may be detachable so that a user can hand the microphone(s) to someone to facilitate a conversation or place the microphone on a table for a meeting. In some implementations, the microphone(s) of the assistive hearing device can be optimized for receiving speech. For example, the microphone(s) can be directional so as to point towards a person the user/wearer of the device is speaking to. Also, the microphones can be more sensitive in the range of the human voice.

The speech recognition engine employed in assistive hearing device implementations may run on a specialized device worn by the user, on the user's smart phone or other mobile computing device, or may be hosted in an intelligent cloud service (e.g., accessed over a network). Similarly, the text-to-speech engine employed by the assistive hearing device may also be run on a specialized device worn by the user, or on the user's smart phone or other mobile computing device, or may be hosted in an intelligent cloud service. The text-to-speech engine may be specially designed for increased speech clarity for users with hearing loss. It may be further customized to a given individual user's hearing-loss profile.

In various assistive hearing device implementations described herein a text transcript of the captured speech may be displayed to a user, such as for example, text can be displayed on a display of a user's smart phone, smart watch or other smart wearable, such as glasses or other augmented or virtual reality display, including displays that project the text directly onto the user's retina. Text can be displayed to the user with or without being coordinated with the synthesized speech output by the loudspeaker or other audio output device.

### 1.2 Exemplary Implementations.

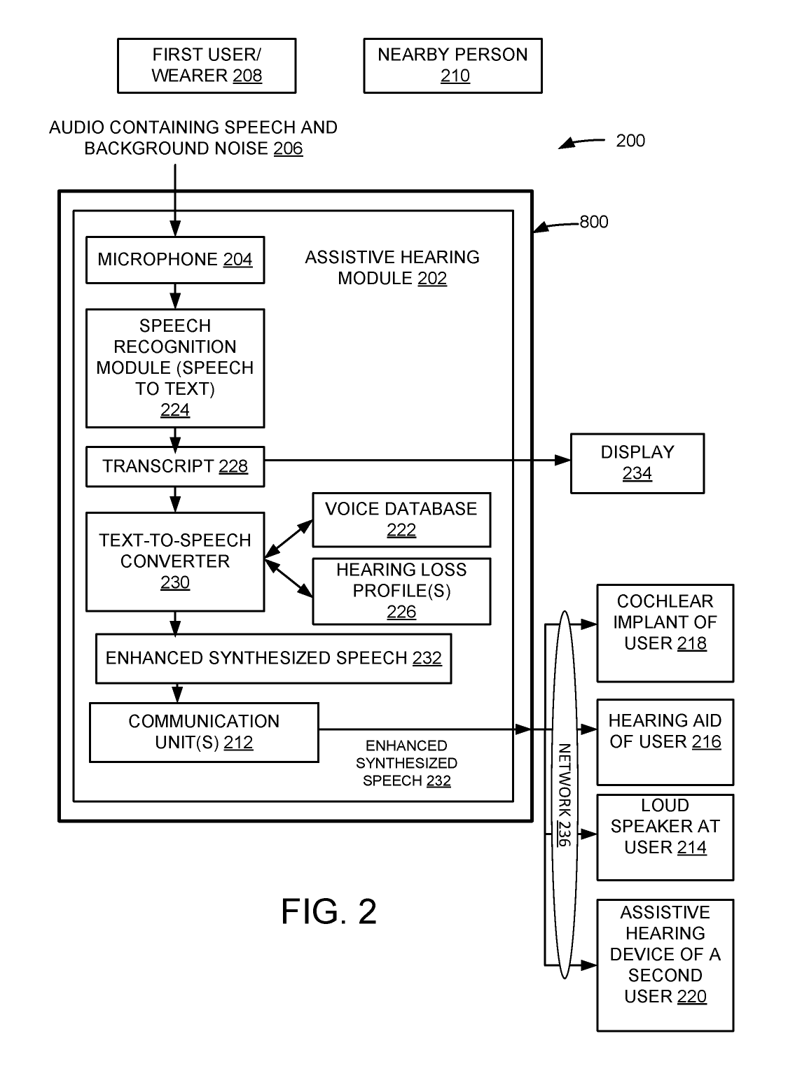

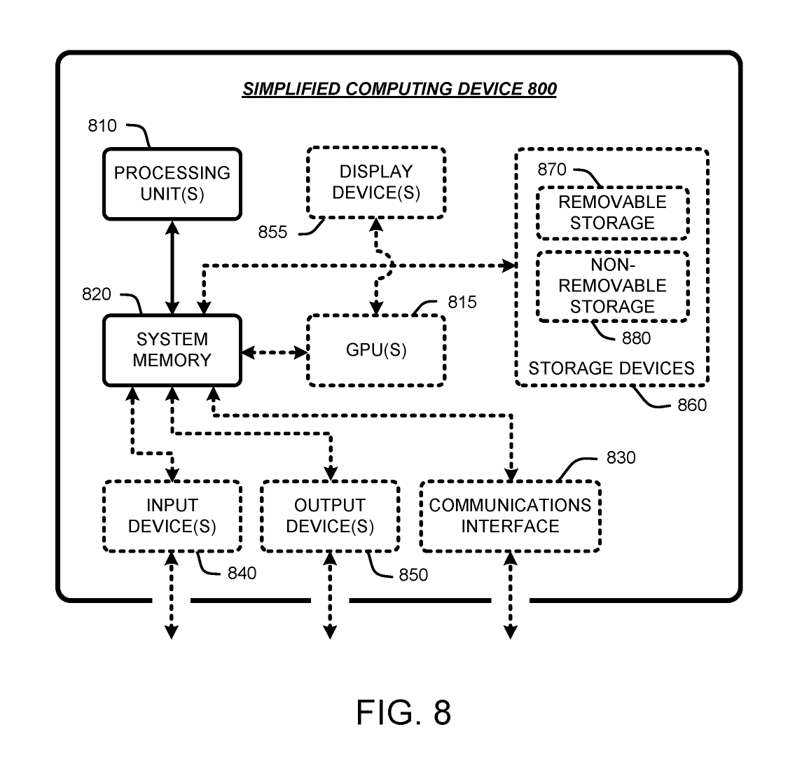

FIG. 2 depicts an assistive hearing device 200 for practicing various assistive hearing device implementations as described herein. As shown in FIG. 2, this assistive hearing device 200 has an assistive hearing module 202 that is implemented on a computing device 800 such as is described in greater detail with respect to FIG. 8. The assistive hearing device 200 includes a microphone (or a microphone array) 204 that captures audio 206 containing speech as well as background noise or sounds. This audio 206 can be the speech of a person 210 nearby to a first user 208 of the assistive hearing device 200 (e.g., a hearing impaired user). In some implementations the assistive hearing device 200 filters the speech of the first user of the assistive hearing device and prevents it from being further processed by the device 200. In other implementations the speech of the first user 208 is further processed by the assistive hearing device 200 for various purposes. For example, transcripts of the first user's speech can be displayed to the first user/wearer 208 and/or transmitted to a second user's assistive hearing device which can output the user's speech to the second user and/or display a transcript 228 of the first user's speech to the second user. In some implementations, in the case of a microphone array, the microphone array can be used for sound source location (SSL) of the participants 208 and 210 in the conversation or to reduce input noise. Also sound source separation can be used to help to identify which participant 208, 210 in a conversation is speaking in order to facilitate subsequent processing of the audio signal 206.

A speech recognition module 224 on the assistive hearing device 200 converts the received audio 206 to text 228. In some implementations the speech recognition module 224 cannot only distinguish the words a speaker is speaking, but can also determine which speaker is speaking them. For example, in some implementations the speech recognition module 224 extracts features from the speech in the audio 206 signals and uses speech models to determine what is being said in order to transcribe the speech to text and thereby generate a transcript 228 of the speech. The speech models are trained with similar features as those extracted from the speech signals. In some implementations the speech models can be trained by the voice of the first user 208 and/or other people speaking. Thus, in some implementations, the speech recognition module can determine which person is speaking to the hearing impaired user 208 by using the speech models to distinguish which person is speaking. Alternately, the assistive hearing device can determine who is speaking to the user 208 by using a directional microphone or a microphone array with beamforming to determine which direction the speech is coming from. Additionally, in some implementations, the assistive hearing device uses images or video of the person who is speaking and uses these to determine who is speaking (e.g., by monitoring the movement of each person's lips). The speech recognition module 224 can output the transcript 228 to a display 234. By transcribing the speech in the original audio signal 206 into text 228, non-speech signals are removed. The first user 208 and/or other people interested in the transcript can view the display 234. For example, the display 234 can be a display on the first user's mobile computing device, smart watch, smart glasses and the like.

The transcript 228 is input to a text-to-speech converter 230 (e.g., a voice synthesizer). The text-to-speech converter 230 then converts the transcript (text) 228 to enhanced speech signals 232 that when played back to the first user 208 of the assistive hearing device 200 are more easily understandable than the original speech. The text-to-speech converter 230 can enhance the speech signals for understandability, for example, by using a voice database 222 and one or more hearing loss profiles 226. A voice with which to output the transcript 228 can be selected from the voice database 222 by selecting a voice that is matched to a hearing loss profile of the user. For example, if the hearing loss profile 226 indicates that the user 208 cannot hear high frequencies, a low frequency voice can be selected from the voice database 222 to output the transcript. Other methods of enhancing or making the synthesized speech more understandable to the user of the assistive hearing device are also possible. For example, certain phonemes can be emphasized to improve clarity. Other ways of making the synthesized speech more understandable to the hearing impaired include adapting the pitch contour to a range appropriate to a user's hearing profile.

The assistive hearing device 200 includes one or more communication unit(s) 212 that send the enhanced speech 232 to an output mechanism, sometimes via a wired or wireless network 236. For example, the assistive hearing device 200 can use the communications unit(s) 212 to output the enhanced synthesized speech to a loudspeaker 214 (or more than one loudspeaker) in or near the ear of the first user/wearer 208. In this implementation, the loudspeaker 214 outputs the enhanced synthesized speech 232 representing the speech in the captured audio signals 206 to be audible to the first user/wearer 208. In some assistive hearing device implementations, instead of outputting the enhanced synthesized speech 232 to a loudspeaker, the assistive hearing device outputs the signals representing the enhanced synthesized speech 232 directly into a conventional hearing aid 216 or a cochlear implant 218 of the first user/wearer. In some implementations, the assistive hearing device 200 can output the signals representing the synthesized speech to another assistive hearing device 220.

The assistive hearing device 200 can further include a way to charge the device (e.g., a battery, a rechargeable battery, equipment to inductively charge the device, etc.) and can also include a control panel which can be used to control various aspects of the device 200. The assistive hearing device 200 can also have other sensors, actuators and control mechanisms which can be used for various purposes such as detecting the orientation or location of the device, sensing gestures, and so forth.

In some implementations the assistive hearing device is worn by the first user/wearer in the form of a wearable device. For example, it can be worn in the form of a necklace (as shown in FIG. 1). In other implementations the assistive hearing device is a wearable assistive hearing device that is in the form of a watch or a wristband. In yet other implementations, the assistive hearing device is in the form of a lapel pin, a badge or name tag holder, a hair piece, a brooch, and so forth. Many types of wearable configurations are possible. Additionally, some assistive hearing devices are not wearable. These assistive hearing devices have the same functionality of wearable assistive hearing devices described herein but have a different form. For example, they may have a magnet or a clip or another means of affixing the assistive hearing device in the vicinity of a user.

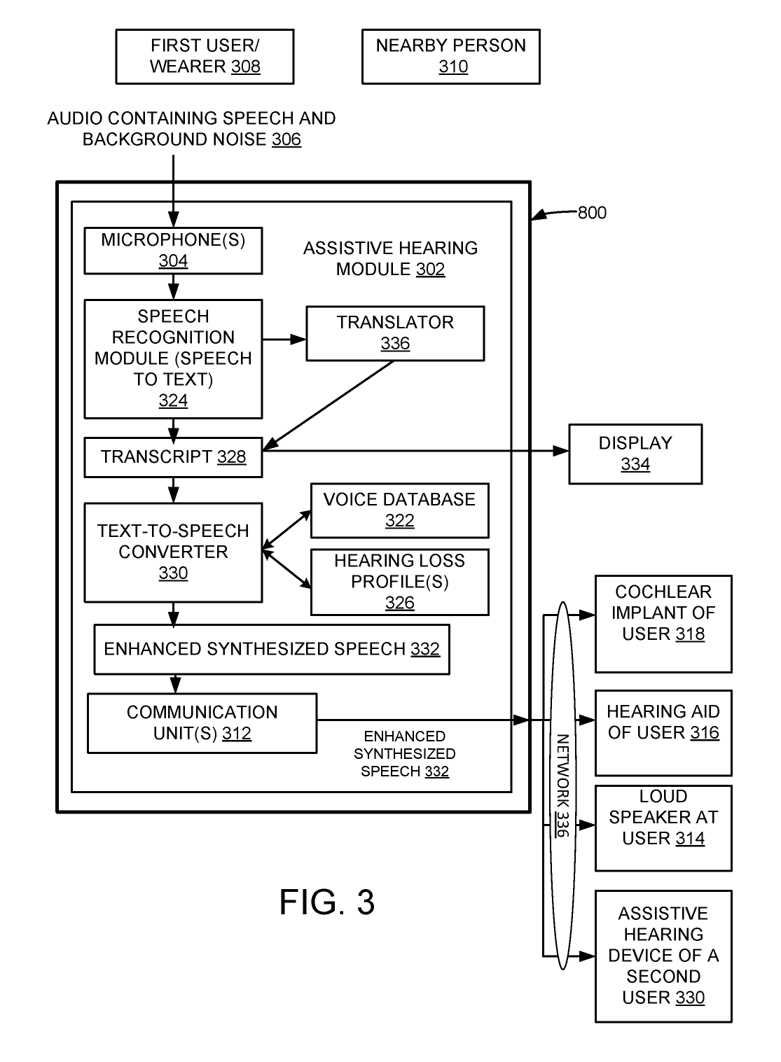

FIG. 3 depicts another exemplary assistive hearing device 300 for practicing various assistive hearing implementations as described herein. Although the exemplary assistive hearing device 300 shown in FIG. 3 operates in a manner similar to the implementation 200 shown in FIG. 2, this assistive hearing device 300 also can include a speech translation module 336. In this implementation the transcribed speech or enhanced synthesized speech can be output in one or more different languages.

As shown in FIG. 3, this assistive hearing device 300 has an assistive hearing module 302 that is implemented on a computing device 800 such as is described in greater detail with respect to FIG. 8. The assistive hearing device 300 includes a microphone (or a microphone array) 304 that captures audio 306 of speech of a first user/wearer 308 of the device and one or more nearby person(s) 310 as well as background noise or sounds. In some implementations the assistive hearing device 300 filters the speech of the first user 308 of the assistive hearing device 300 and prevents it from being further processed by the device 300. In other implementations the speech of the first user 308 is also further processed by the assistive hearing device for various purposes. For example, transcripts of the first user's speech can be displayed to the first user/wearer 308 and/or transmitted to a second user's assistive hearing device which can output the first user's speech to the second user (not shown) and/or display a transcript 328 of the first user's speech to the second user. In some implementations, in the case of a microphone array 304, the microphone array can be used for sound source location (SSL) of the participants 308, 310 in the conversation or to reduce input noise. Also sound source separation can be used to help to identify which participant 308, 310 in a conversation is speaking in order to facilitate subsequent processing of the audio signal 306.

A speech recognition module 324 of the assistive hearing device 300 converts the speech in the received audio 306 to text 328. The speech recognition module 324 extracts features from the speech in the audio signal and uses speech models to determine what is being said in order to transcribe the speech to text and thereby generate the transcript 328 of the speech. The speech models are trained with similar features as those extracted from the speech in the audio signals. In some implementations the speech models can be trained by the voice of the first user and/or other people speaking. The speech recognition module 324 can output the transcript 328 to a display 334. The first user 308 and/or other people interested in the transcript 328 can then view it on the display 334. For example, the display 334 can be a display on the first user's mobile computing device, smart watch, smart glasses or the like.

The transcript 328 is input to a text-to-speech converter 330 (e.g., a voice synthesizer). The text-to-speech converter 330 can then convert the transcript (text) 328 to enhanced speech signals 332 that when played back to the first user 308 are more easily understood than the original speech. In some implementations, the text-to-speech converter 330 enhances the speech for understandability by using a voice database 322 and one or more hearing loss profiles 326. A voice with which to output the transcript can be selected from the voice database 322 by selecting a voice that is matched to a hearing loss profile of the user. For example, if the hearing loss profile 326 indicates that the user cannot hear high frequencies a low frequency voice can be selected from the voice database 322 to output the transcript. Other methods of making the voice more understandable to the user of the assistive hearing device are also possible. By transcribing the speech in the original audio signal into text, non-speech sounds are removed. When the text is then converted to synthesized speech the understandability of the synthesized speech is enhanced by including only the linguistic components of the speech for someone that is hard of hearing. This can be done, for example, by selecting a voice to output the synthesized speech that has characteristics within the hearing range of the user. Certain phonemes can be emphasized to improve clarity.

The assistive hearing device 300 includes one or more communication unit(s) 312 that send the enhanced speech 332 to an output mechanism, sometimes via a wired or wireless network 336. For example, the assistive hearing device 300 can include a loudspeaker 314 (or more than one loudspeaker) in or near the ear of the first user/wearer 308. In this implementation, the loudspeaker 314 outputs the enhanced synthesized speech 332 representing the speech in the captured audio signals 306 to be audible to the first user/wearer 306. In some assistive hearing device implementations, as discussed above, instead of outputting the enhanced synthesized speech 332 to a loudspeaker, the assistive hearing device 300 outputs the signals representing the enhanced synthesized speech 332 directly in to a conventional hearing aid 316 or a cochlear implant 318 of the first user/wearer. In some implementations, the assistive hearing device 300 can output the signals representing the synthesized speech to another assistive hearing device 330.

As discussed above, this assistive hearing device implementation can translate the original speech in the received audio signal to one or more different languages, For example, the translator 336 can translate the input speech in a first language into a second language. This can be done, for example, by using a dictionary to determine possible translation candidates for each word or phoneme in the received speech and using machine learning to pick the best translation candidates for a given input. In one implementation, the translator 336 generates a translated transcript 328 (e.g., translated text) of the input speech. This translated transcript 328 can be displayed to one or more people. The translated text/transcript 328 can also be converted to an output speech signal by using the text-to-speech converter 330. The output speech in the second language can be enhanced in order to make the speech more understandable to a hearing impaired user. The enhanced synthesized speech 332 (which can be translated into the second language) is output by the loudspeaker (or loudspeakers) 314 or to the display or to other output mechanisms.

In some implementations, the assistive hearing device 300 can determine a geographic location and use this location information for various purposes (e.g., to determine at least one language of the speech to be translated). In some implementations, the geographic location can be computed by using the location of cell phone tower IDs, Wi-Fi Service Set Identifiers (SSIDs) or Bluetooth Low Energy (BLE) nodes.

As discussed previously, the text/transcript 328 can be displayed on a display 334 of the device 302 (or some other display (not shown)). In one implementation the text/transcript 328 is displayed at the same time the enhanced is output by the loudspeaker 314 or other audio output device, such as, for example, a hearing aid, cochlear implant, or mobile phone. This implementation is particularly beneficial for completely deaf participants in the conversation because they can read the transcript and participate in the conversation even if they cannot hear the speech output through the loudspeaker. In some implementations the text or transcript 328 can be projected directly onto the retina of the user's eye. (This may be done by projecting an image of the text by using a retina projector that focuses laser light through beam splitters and concave mirrors so as to create a raster display of the text on the back of the eye.)

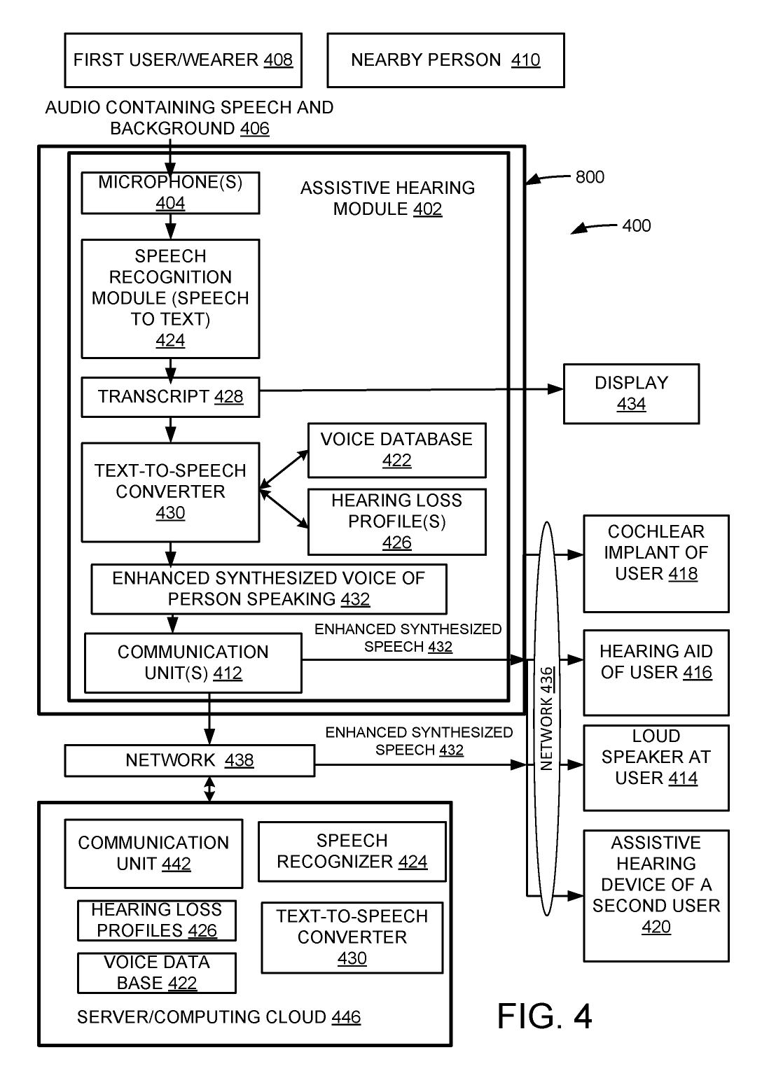

Yet another assistive hearing device implementation 400 is shown in FIG. 4. The assistive hearing device 400 operates in a manner similar to the implementations shown in FIGS. 2 and 3 but also communicates with a server or computing cloud 446 that receives information from the assistive hearing device 400 and sends information to the assistive hearing device 400 via a network 438 and communication capabilities 412 and 442. This assistive hearing device 400 has an assistive hearing module 402 that is implemented on a computing device 800 such as is described in greater detail with respect to FIG. 8. The assistive computing device 400 includes at least one microphone 404 that captures input signals 406 representing nearby speech.

A speech recognition module 424 converts the speech in the received audio 406 to text 428. The speech recognition module 424 can reside on the assistive hearing device 400 and/or on a server or computing cloud 446 (discussed in greater detail below). As previously discussed, the speech recognition module 424 extracts features from the speech from the audio 406 and uses speech recognition models to determine what is being said in order to transcribe the speech to text and thereby generate the transcript 428 of the speech. The speech recognition module 424 can output the transcript 428 to a display 434 where people interested in it can view it.

The transcript 428 can be input to a text-to-speech converter 430 (e.g., a voice synthesizer). This text-to-speech converter 430 can reside on the assistive hearing device 400 or on a server or computing cloud 446 (discussed in greater detail below). The text-to-speech converter 430 converts the transcript (text) 428 to enhanced speech that when played back to the first user of the assistive hearing device 400 is more easily understandable than the original speech. In some assistive hearing device implementations, the text-to-speech converter 430 enhances the speech signals for understandability by using a voice database 422 and one or more hearing loss profiles 426. A voice with which to output the transcript 428 can be selected from the voice database 422 by selecting a voice that is matched to a hearing loss profile 426 of the user Other methods of making the speech more understandable to the user of the assistive hearing device are also possible. By transcribing the speech in the original audio signal into text, non-speech sounds are removed. When the text is then converted to synthesized speech using the text-to-speech converter 430 the synthesized speech is enhanced by modifying the linguistic components of the speech for someone that is hard of hearing. This can be done, for example, by selecting a voice to output the synthesized speech that has characteristics in the hearing range of the user.

The communication unit(s) 412 can send the captured input signals 406 representing speech to the communication unit 442 of the server/computing cloud 446, and can receive text, language translations or synthesized speech signals 432 from the server/computing cloud. In one implementation, the assistive computing device 400 can determine a geographic location using a GPS (not shown) on the assistive computing device and provide the location information to the server/computing cloud 446. The server/computing cloud 446 can then use this location information for various purposes, such as, for example, to determine a probable language spoken. The assistive computing device 400 can also share processing with the server or computing cloud 446 in order to process the audio signals 406 containing speech captured by the assistive computing device. In one implementation the server/computing cloud 446 can run a speech recognizer 424 to convert the speech in the received audio to text and a text-to-speech converter 430 to convert the text to synthesized speech. Alternately, the speech recognizer 424 and/or the text-to-speech converter 430 can run on the assistive hearing device 400.

In one implementation the transcript 428 is sent from the server/computing cloud 446 to the assistive hearing device 400 and displayed on a display 434 of the assistive computing device 400 or the display of a different device (not shown). In one implementation the transcript 428 is displayed at the same time the enhanced speech is output by the loudspeaker 414, the conventional hearing aid 416 or cochlear implant 418.

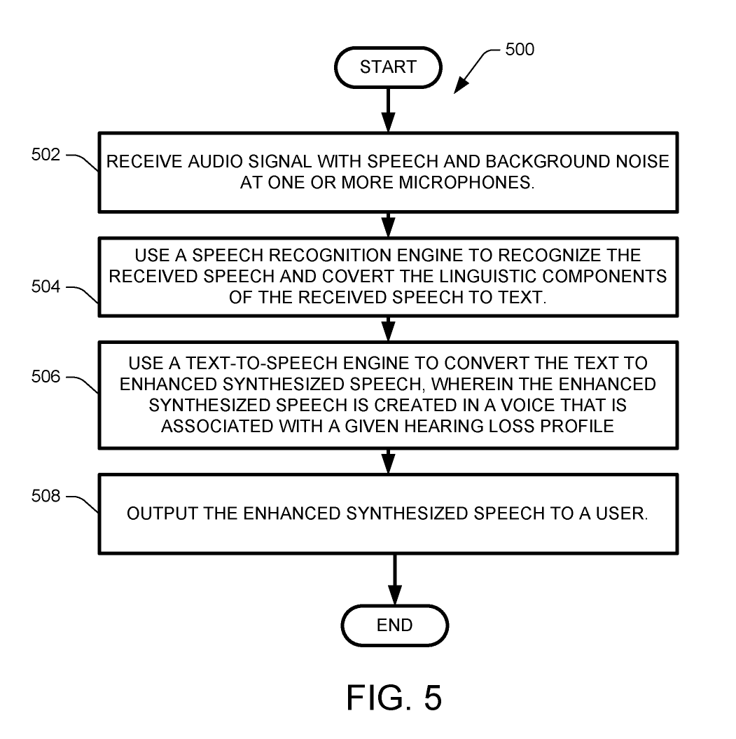

FIG. 5 depicts an exemplary computer-implemented process 500 for practicing various hearing assistance implementations. As shown in FIG. 5, block 502, input signals containing speech with background noise are received at one or more microphones. These microphone(s) can be designed to be optimized for speech recognition. For example, the microphone(s) can be directional so as to capture sound from only one direction (e.g., the direction towards a person speaking). A speech recognition engine is used to recognize the received speech and convert the linguistic components of the received speech to text, as shown in block 504. The speech recognition engine can run on a device, a server or a computing cloud. A text-to-speech engine is used to convert the text to enhanced synthesized speech, wherein the enhanced synthesized speech is created in a voice that is associated with a given hearing loss profile, as shown in block 506. The hearing loss profile can be selectable by a user. The text-to-speech engine can run on a device, a server or on a computing cloud. The enhanced synthesized speech is output to a user, as shown in block 508. A voice to output the enhanced synthesized speech can be selectable by the user. For example, in some implementations the voice the enhanced synthesized speech is output with is selectable from a group of voices, each voice having its own pitch contour. This process 500 can occur in real-time so that the user can hear the enhanced speech at essentially the same time that the speech is being spoken and, in some implementations, see a transcript of the speech on a display at the same time.

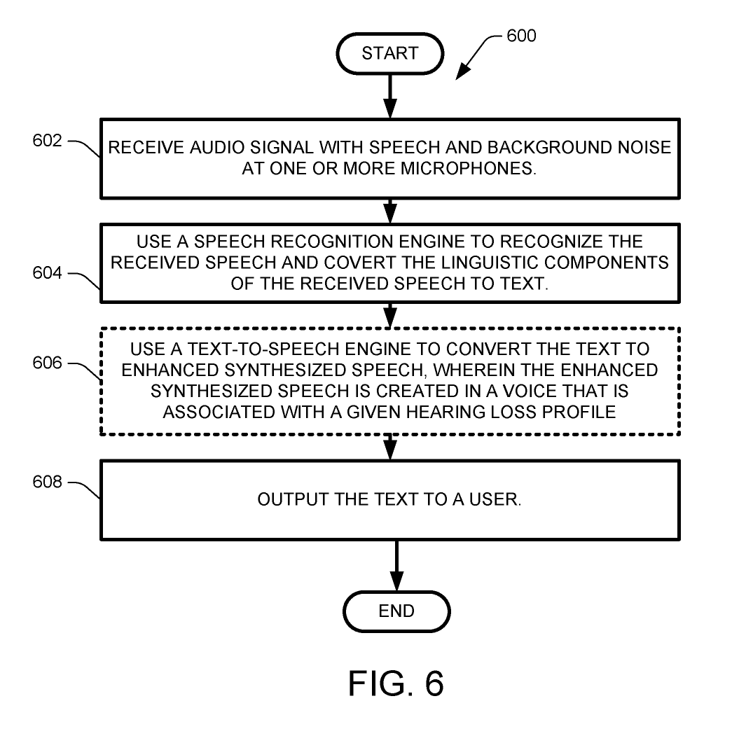

FIG. 6 depicts another exemplary computer-implemented process 600 for practicing various hearing assistance implementations. As shown in FIG. 6, block 602, input signals containing speech with background noise are received at one or more microphones. The microphone(s) can be directional so as to capture sound from only one direction (e.g., the direction towards a person speaking). A speech recognition engine is used to recognize the received speech and convert the linguistic components of the received speech to text, as shown in block 604. The speech recognition engine can run on a device, server or computing cloud. In some implementations, a text-to-speech engine, if used, can optionally be used to convert the text to enhanced synthesized speech, wherein the enhanced synthesized speech is created so as to be more understandable to a hearing impaired person, as shown in block 606 (the dotted line indicates that this is an optional block/step). The text-to-speech engine can run on a device, a server or on a computing cloud. The text is output to a user, as shown in block 608. For example, the text can be displayed on a display or printed using a printer. This process can occur in real-time so that the user sees a transcript of the speech on a display at the same time that the speech is spoken. Similarly, in cases where synthesized speech is output, it can be output at essentially the same time the transcript is output.

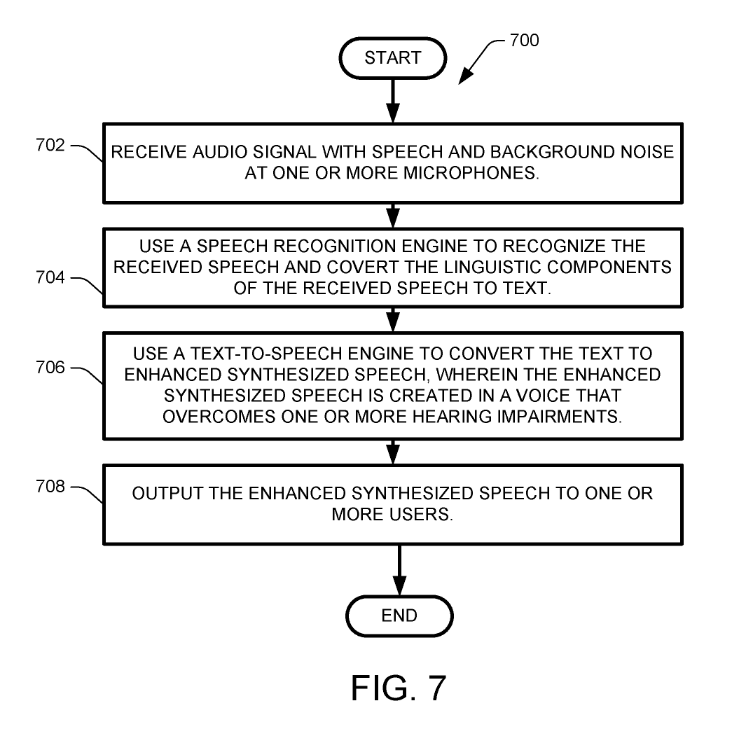

FIG. 7 depicts another exemplary computer-implemented process 700 for practicing various hearing assistance implementations as described herein. As shown in FIG. 7, block 702, signals containing speech with background noise are received at one or more microphones. As discussed above, a speech recognition engine is used to recognize the received speech and convert the linguistic components of the received speech to text, as shown in block 704. The speech recognition engine can run on a device, server or computing cloud. A text-to-speech engine is used to convert the text to enhanced synthesized speech, as shown in block 706. The enhanced synthesized speech can be created in a voice that overcomes one or more hearing impairments. The text-to-speech engine can run on a device, a server or on a computing cloud. The synthesized speech is output to one or more users, as shown in block 708. This process 700 can occur in real-time so that the user can hear the enhanced speech at essentially the same time that the speech is being spoken, with or without a transcript of the input speech being displayed on a display.

### 1.3 Exemplary Usage Scenarios.

The following paragraphs describe various exemplary real world scenarios in which the assistive hearing device implementations described herein can be used to help the hearing impaired. These examples are provided to touch on a few of the possibilities afforded by the assistive hearing device implementations. They are not meant to be an exhaustive list or limit the scope of the assistive hearing device implementations in any way.

### 1.3.1 Scenario 1: Mild Hearing Loss/Occasional Assist.

In a first usage scenario an individual with mild hearing loss can usually hear well enough to manage, but sometimes misses a few crucial words of what is said, and then cannot follow a conversation. Sometimes the individual asks the speaker to repeat, but in most social situations the hearing impaired individual finds that disruptive and embarrassing, so he or she just smiles and says nothing. Usually people do not notice, but over time the person feels disconnected from friends and family. As the hearing impaired individual's hearing gets worse, he or she can slide towards isolation and depression.

With the hearing assistive device implementations described herein, the hearing impaired individual can now wear a discreet microphone (such as a lapel microphone) that captures everything that is spoken to him or her. It may be directional, so at parties it works well if the individual faces the person talking to them. When the individual misses something he or she can glance at a display such as their smart watch, which displays a transcript of the last thing that was said. The individual can also scroll through the transcript to see the previous utterances, so they can be sure they are following the conversation. When they do not have such a watch, they can see the same information on their mobile phone.

### 1.3.2 Scenario 2: Profound Hearing Loss.

In a second usage scenario, after a viral illness a few years back an individual suddenly finds that they had lost almost all hearing in both ears. They spent years trying many different, very expensive, hearing aids. These hearing aids all helped a little, but none came close to restoring the person's hearing to full functioning. The individual eventually retired early because they just could not cope at work. They used to be a really social person, but now find that they spend most of their time reading and watching movies (with captions).

With the hearing assistive device the person with profound hearing loss now wears a pair of glasses that caption real life for them. A pair of powerful directional microphones built into the glasses captures the speech of whoever the person is looking at. Even at a noisy party, if they look at the person speaking, it isolates their speech from the surrounding noise. The person with profound hearing loss then see captions under the person's face. The captions can be projected directly onto the user's retina. They can see that the captions do not quite track the speaker's mouth movements, but that is alright because he or she can be social again, talk with their friends at parties, or one-on-one.

### 1.3.3 Scenario 3: Elderly Couple

In a third usage scenario, as a husband and wife have gotten older, their hearing has deteriorated little by little. They tried cheap hearing aids, but they did not do much for them. Possibly more expensive ones would work better, but Medicare does not pay for them, and they cannot afford them. They came up with a nifty system of notes. Every surface in their house has a notepad and a pen. It beats screaming at each other all the time, and it saved their marriage. The note system does not work so well if they are in different rooms, however.

The couple's daughter bought them a pair of smart phones with a hearing assistance app as described herein installed, plus a little Bluetooth earpiece. The app always listens to each party. Now the husband or wife can just speak in a normal voice, and whatever they say gets recognized as words and gets played back in their spouse's earpiece. The playback voice was customized to the parts of the spectrum where they can still hear well. They can make out the words clearly. The same words are displayed on their phones as well, so they can check that to make sure that they did not misunderstand. Best of all it works even if they are in different parts of the house.

### 1.3.4 Scenario 4: Classroom

Being deaf from birth, a deaf student is typically faced with the choice of attending a special school for the deaf that provides sign language interpreters, or attending a school for non-deaf students, where they cannot hear most of what is being said.

In contrast, in a school equipped with a hearing assistance device and system as described herein, deaf users can interact more effectively with the hearing world. Every class the deaf student walks into has a Quick Response (QR) code or room code posted by the door. The student launches the hearing assistance app on their phone or tablet, scans or key in the code, and immediately he or she has captions for everything the teacher is saying. The teachers all wear a lapel microphone or headset, so the accuracy of the captions is really good. The student can now understand everything the teacher is saying.

### 2.0 Other Implementations

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the implementations described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

Various assistive hearing device implementations are by means, systems processes for assisting a hearing impaired user in hearing and understanding speech by using automated speech transcription.

As a first example, assistive hearing device implementations are implemented in a device that improves the ability of the hearing impaired to understand speech. The system device comprises one or more microphones; a speech recognition engine that recognizes speech directed at a hearing impaired user in received audio and converts the recognized speech directed at the hearing impaired user in the received audio into text; and a display that displays the recognized text to the user.

As a second example, in various implementations, the first example is further modified by means, processes or techniques such that a text-to-speech engine converts the text to enhanced synthesized speech for the user.

As a third example, in various implementations, the first example is further modified by means, processes or techniques such that the text is displayed on a display of the user's smart phone.

As a fourth example, in various implementations, the first example is further modified by means, processes or techniques such that the text is displayed on a display of the user's smart watch.

As a fifth example in various implementations, the first example, is further modified by means, processes or techniques such that the text is displayed to the user in a virtual-reality or augmented-reality display.

As a sixth example, in various implementations, the first example, the second example, the third example, the fourth example or the fifth example is further modified by means, processes or techniques such that the text is displayed to the user such that it appears visually to be associated with the face of the person speaking.

As a seventh example, in various implementations, the first example, the second example, the third example, the fourth example, the fifth example or the sixth example are further modified by means, processes or techniques such that one or more microphones are detachable from the device.

As an eighth example, assistive hearing device implementations are implemented in a device that improves the ability of the hearing impaired to understand speech. The system device comprises one or more microphones; a speech recognition engine that recognizes speech in received audio and converts the linguistic components of the received audio into text; a text-to-speech engine that converts the text to enhanced synthesized speech, wherein the enhanced synthesized speech enhances the linguistic components of the input speech for a user; and an output modality that outputs the enhanced synthesized speech to the user.

As a ninth example, in various implementations, the eighth example is further modified by means, processes or techniques such that the output modality outputs the enhanced synthesized speech to a hearing aid of the user.

As a tenth example, in various implementations, the eighth example is further modified by means, processes or techniques such that the output modality outputs the enhanced synthesized speech to a cochlear implant of a user.

As an eleventh example in various implementations, the eighth example, is further modified by means, processes or techniques such that the output modality outputs the enhanced synthesized speech to a loudspeaker that the user is wearing.

As a twelfth example, in various implementations, the eighth example, the ninth example, the tenth example or the eleventh example is further modified by means, processes or techniques to further comprise a display on which the text is displayed to the user at essentially the same time the enhanced synthesized speech corresponding to the text is output.

As a thirteenth example, in various implementations, the eighth example, the ninth example, the tenth example, the eleventh example or the twelfth example are further modified by means, processes or techniques to enhance the synthesized speech to conform to the user's hearing loss profile.

As a fourteenth example, in various implementations, the eighth example, the ninth example, the tenth example, the eleventh example, the twelfth example or the thirteenth example are further modified by means, processes or techniques to enhance the synthesized speech by changing the synthesized speech to a pitch range where speech is more easily understood by the user.

As a fifteenth example, in various implementations, the eighth example, the ninth example, the tenth example, the eleventh example, the twelfth example, the thirteenth example or the fourteenth example is further modified by means, processes or techniques such that the one or more microphones are directional.

As a sixteenth example, in various implementations, the eighth example, the ninth example, the tenth example, the eleventh example, the twelfth example, the thirteenth example, the fourteenth example or the fifteenth example is further modified by means, processes or techniques such that the enhanced synthesized speech is translated into a different language from the input speech.

As a seventeenth example, assistive hearing device implementations are implemented in a process that provides for an assistive hearing device with automated speech transcription. The process uses one or more computing devices for: receiving an audio signal with speech and background noise at one or more microphones; using a speech recognition engine to recognize the received speech and convert the linguistic components of the received speech to text; using a text-to-speech engine to convert the text to enhanced synthesized speech, wherein the enhanced synthesized speech is created in a voice that is associated with a given hearing loss profile; and outputting the enhanced synthesized speech to a user.

As an eighteenth example, in various implementations, the seventeenth example is further modified by means, processes or techniques such that the voice to output the enhanced synthesized speech is selectable by the user.

As a nineteenth example, assistive hearing device implementations are implemented in a system that assists hearing with automated speech transcription. The process uses one or more computing devices, the computing devices being in communication with each other whenever there is a plurality of computing devices. The computer program has a plurality of sub-programs executable by the one or more computing devices, the one or more computing devices being directed by the sub-programs of the computer program to, receive speech with background noise at one or more microphones at a first user; use a speech recognition engine to recognize the received speech and convert the linguistic components of the received speech to text; use a text-to-speech engine to convert the text to synthesized speech, wherein the synthesized speech is designed to enhance the linguistic components of the input speech so as to be more understandable to a user that is hard of hearing; and output the enhanced synthesized speech to a second user.

As a twentieth example, in various implementations, the twentieth example is further modified by means, processes or techniques such that the enhanced synthesized speech is sent over a network before being output to a second user.

### 3.0 Exemplary Operating Environment:

The assistive hearing device implementations described herein are operational within numerous types of general purpose or special purpose computing system environments or configurations. FIG. 8 illustrates a simplified example of a general-purpose computer system on which various elements of the assistive hearing device implementations, as described herein, may be implemented. It is noted that any boxes that are represented by broken or dashed lines in the simplified computing device 800 shown in FIG. 8 represent alternate implementations of the simplified computing device. As described below, any or all of these alternate implementations may be used in combination with other alternate implementations that are described throughout this document.

The simplified computing device 800 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the assistive hearing device implementations described herein, the device should have a sufficient computational capability and system memory to enable basic computational operations. In particular, the computational capability of the simplified computing device 800 shown in FIG. 8 is generally illustrated by one or more processing unit(s) 810, and may also include one or more graphics processing units (GPUs) 815, either or both in communication with system memory 820. Note that that the processing unit(s) 810 of the simplified computing device 800 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 800 may also include other components, such as, for example, a communications interface 830. The simplified computing device 800 may also include one or more conventional computer input devices 840 (e.g., touch screens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 600 and with any other component or feature of the assistive hearing device implementations, including input, output, control, feedback, and response to one or more users or other devices or systems associated with the assistive hearing device implementations, are enabled by a variety of Natural User Interface (NUI) scenarios. The NUI techniques and scenarios enabled by the assistive hearing device implementations include, but are not limited to, interface technologies that allow one or more users user to interact with the assistive hearing device implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 840 or system sensors. Such NUI implementations are also enabled by the use of various techniques including, but not limited to, information derived from system sensors or other input devices 840 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the assistive hearing device implementations.

However, it should be understood that the aforementioned exemplary NUI scenarios may be further augmented by combining the use of artificial constraints or additional signals with any combination of NUI inputs. Such artificial constraints or additional signals may be imposed or generated by input devices 640 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the assistive hearing device implementations.

The simplified computing device 800 may also include other optional components such as one or more conventional computer output devices 850 (e.g., display device(s) 855, audio output devices, video output devices, devices for transmitting wired or wireless data transmissions, and the like). Note that typical communications interfaces 830, input devices 840, output devices 850, and storage devices 860 for general-purpose computers are well known to those skilled in the art, and will not be described in detail herein.

The simplified computing device 800 shown in FIG. 8 may also include a variety of computer-readable media. Computer-readable media can be any available media that can be accessed by the computing device 800 via storage devices 860, and include both volatile and nonvolatile media that is either removable 870 and/or non-removable 880, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), blue-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various assistive hearing device implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The assistive hearing device implementations described herein may be further described in the general context of computer-executable instructions, such as program modules, being executed by a computing device. Generally, program modules include routines, programs, objects, components, data structures, and the like, that perform particular tasks or implement particular abstract data types. The assistive hearing device implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

The foregoing description of the assistive hearing device implementations have been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate implementations may be used in any combination desired to form additional hybrid implementations. It is intended that the scope of the invention be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. A device for assisting a hearing impaired user, comprising:
one or more microphones that capture audio of a person's speech directed at the hearing impaired user;
a speech recognition engine that recognizes the speech directed at the hearing impaired user in the audio and converts the recognized speech directed at the hearing impaired user in the received audio to text; and
a display that displays the text.

2. The device of claim 1, further comprising a text-to-speech engine that converts the text to enhanced synthesized speech, wherein the enhanced synthesized speech enhances the linguistic components of the input speech for the user.

3. The device of claim 1, wherein the text is displayed on a display of the user's smart phone.

4. The device of claim 1, wherein the text is displayed on a display of the user's smart watch.

5. The device of claim 1, wherein the text is displayed to the user in a virtual-reality or augmented-reality display.

6. The device of claim 1, wherein the text is displayed to the user such that it appears visually to be associated with the face of the person speaking.

7. The device of claim 1, wherein the one or more microphones are detachable from the device.

8. A device for assisting in improved hearing, comprising:
one or more microphones;
a speech recognition engine that recognizes input speech in received audio and converts the linguistic components of the received audio to text;
a text-to-speech engine that converts the text to enhanced synthesized speech, wherein the enhanced synthesized speech enhances the linguistic components of the input speech for a user; and
an output modality that outputs the enhanced synthesized speech to the user.

9. The device of claim 8, wherein the output modality outputs the enhanced synthesized speech to a hearing aid in the ear of the user.

10. The device of claim 8, wherein the output modality outputs the enhanced synthesized speech to a cochlear implant of the user.

11. The device of claim 8, wherein the output modality outputs the enhanced synthesized speech to a loudspeaker that the user is wearing.

12. The device of claim 8, further comprising a display on which the text is displayed to the user at the same time the enhanced synthesized speech corresponding to the text is output.

13. The device of claim 8, wherein the synthesized speech is enhanced to conform to the user's hearing loss profile.

14. The device of claim 8, wherein the synthesized speech is enhanced by changing the quality of the synthesized speech to a pitch range that is more easily heard by the user.

15. The device of claim 8, wherein the one or more microphones are directional.

16. The device of claim 8, wherein the enhanced synthesized speech or the text is translated into a different language from the input speech.

17. A process for providing hearing assistance, comprising:
using one or more computing devices for:
receiving an audio signal with speech and background noise at one or more microphones;
using a speech recognition engine to recognize the received speech and convert the linguistic components of the received speech to text;
using a text-to-speech engine to convert the text to enhanced synthesized speech, wherein the enhanced synthesized speech is created in a voice that is associated with a given hearing loss profile; and
outputting the enhanced synthesized speech to a user.

18. The process of claim 17, wherein the voice to output the enhanced synthesized speech is selectable by the user.

19. A system for providing hearing assistance, comprising:
one or more computing devices, said computing devices being in communication with each other whenever there is a plurality of computing devices, and a computer program having a plurality of sub-programs executable by the one or more computing devices, the one or more computing devices being directed by the sub-programs of the computer program to,
receive audio of speech with background noise at one or more microphones associated with a first user;
use a speech recognition engine to recognize the received speech and convert the linguistic components of the received speech to text;
use a text-to-speech engine to convert the text to synthesized speech, wherein the synthesized speech is designed to enhance the linguistic components of the input speech so as to be more understandable to a user that is hard of hearing; and
output the enhanced synthesized speech to a second user.

20. The system of claim 19 wherein the enhanced synthesized speech is sent over a network before being output to the second user.
